(19) United States
(12) Patent Application Publication
(10) Pub. No.: US 2011/0247697 A1
(43) Pub. Date: Oct. 13, 2011

(54) METHOD OF PROCESSING FLUID FROM A WELL

(75) Inventor: Frode Hansen, Hammerfest (NO)

(73) Assignee: STATOIL PETROLEUM AS, Stavanger (NO)

(21) Appl. No.: 13/127,375

(22) PCT Filed: Nov. 3, 2009
(86) PCT No.: PCT/NO2009/000381

§ 371 Date: Jun. 27, 2011

(30) Foreign Application Priority Data
Nov. 3, 2008 (NO) 20084621

(51) Int. Cl. F17D 3/00

(52) U.S. Cl. 137/2

(57) ABSTRACT

There is described a method of processing fluid from a well. In an embodiment, a fluid processing system is operable to process fluids from a well in dependence on a plurality of controllable system parameters. The parameters are adjusted between respective first and second parameter values, and the first values define a first operational configuration and the second values defining a second, different operational configuration. The adjustment is carried out such that the system is balanced whilst adjusting the parameters. This may be done by adjusting the value of each parameter simultaneously along linear curves from a first initial value to a second end value. In the second configuration, activation or deactivation of a compressor (30) can take place without disrupting the system. The compressor is used to increase the rate of flow of processed fluid from the system.

The present invention relates to a method of processing fluid from a well. In a particular embodiment, the method relates to a fluid processing system operable to process fluids from a well in dependence on a plurality of controllable system parameters.

In the recovery of fluids from subsurface wells, it is generally necessary to process those fluids in different ways, for example to remove contaminants or to purify the fluids, before they can be used. In oil and gas production, hydrocarbon fluids that have been extracted from the well are normally processed in a fluid processing facility to separate oil and gas from the raw well fluid.

An object of many such plants is to prepare the gas so that it can be exported from the processing facility onshore ready for sale. It is therefore imperative that the gas meets the required sale specification when leaving the processing facility. For example, the gas leaving the facility should have a specific temperature, pressure and purity, to qualify as “sales gas”.

At the same time, it is commercially desirable to export gas from the facility at high volumetric flow rates in order to meet demand and maintain profit levels. This can be problematic because the pressure of fluids entering the processing facility from the well reduces after a number of years of production as the reservoir becomes depleted. It is therefore necessary to take steps to compensate for this reduction in fluid pressure in order to achieve a consistent export of “sales gas” at a high flow rate. In existing solutions, this is known to be done by connecting a compressor near the inlet to the processing facility to boost the pressure and/or flow rates downstream thereof, i.e. a “pre-compressor”.

A further consideration is that the processing facility and system must be operated within set operating bounds in order to ensure that the sales gas meets its required specification. To ensure that this is adhered to, the system is advance prepared for connection of the pre-compressor so that as it is connected, the system can continue to process the gas for export without the sales gas departing from the specification.

In the course of a year, production of fluid from the well is turned off and back on again several times. This requires connection of the pre-compressor each time the well is switched on, in order to reach full production. Conversely, the pre-compressor must be disconnected, in reverse sequence, when the well flow is turned off. On each occasion, the processing system must be prepared into a connection state for connection of the pre-compressor and then taken back to a default state after disconnection of the pre-compressor when (before) the well flow is turned off. The state of the system is monitored and controlled from a control interface by an operator of the processing facility.

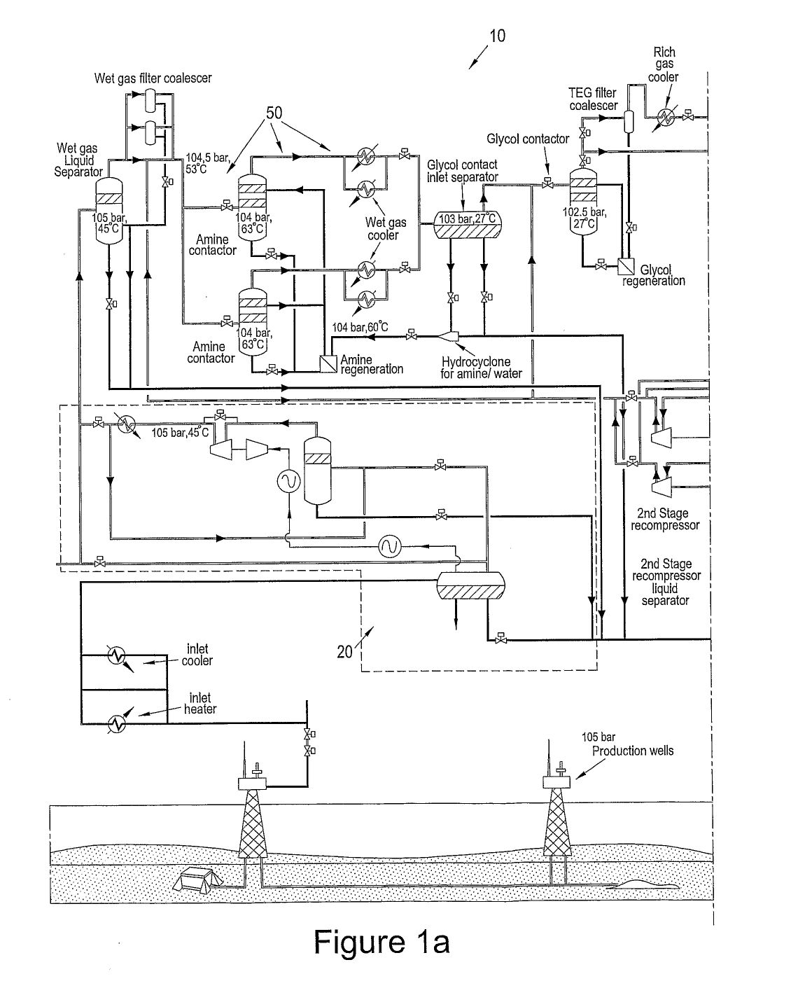

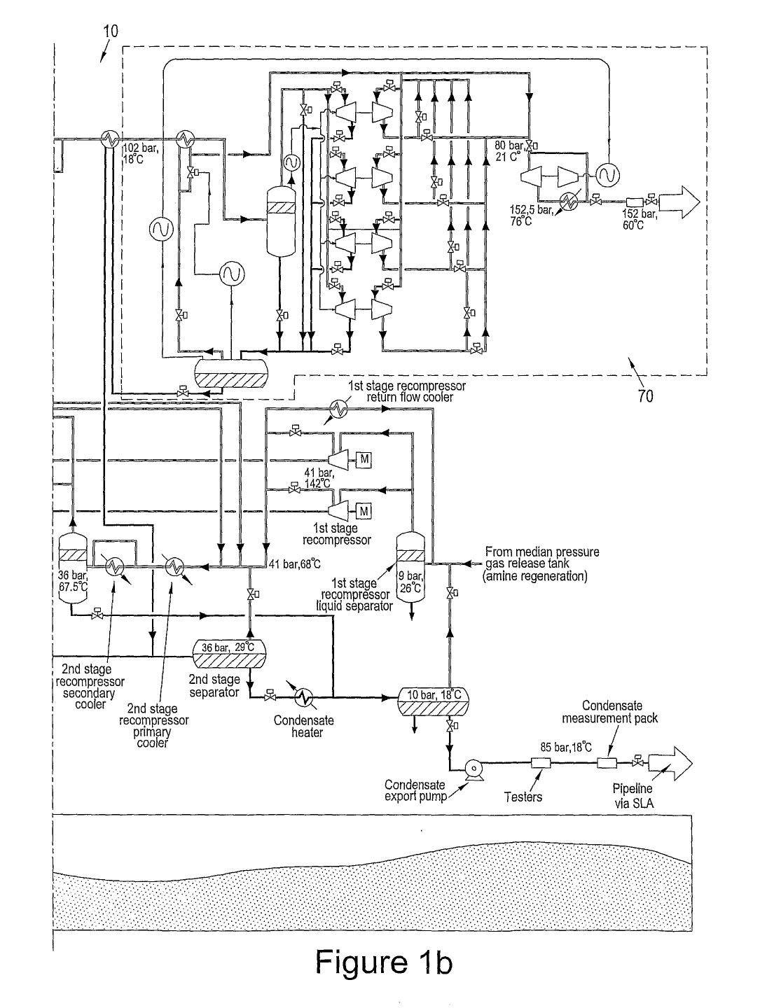

An example of the operation and preparation of such a fluid processing facility and connection of the pre-compressor is described with reference to FIGS. 1 to 3. A facility 10 is provided with an inlet arrangement 20 into which raw well fluid is received through the pipeline 12. The arrangement includes an inlet separator 22 and a pre-compressor 30. The well fluid is carried via pipeline 12 into the inlet separator 22 which separates the well fluid into gas and liquid fractions. Liquids settle out in the separator (taking the form of a tank) and are guided away from the separator 22 through a condensate pipeline 13 and are eventually pumped away from the facility through a transport pipeline.

The gas is carried out of the inlet separator 22 either toward the pre-compressor 30 via inlet gas pipeline 24i, which connects the pre-compressor separator 24 with the inlet separator 22, or past the pre-compressor 30 through a pre-compressor bypass pipeline 24b dependant on whether the pre-compressor is being used. For example, the pre-compressor may not be in use when the equipment is in its default state before being prepared into the pre-compressor connection state. Flow valves 24v, 24w provided in pipelines 24i, 24b can be closed or opened to selectively permit or prevent flow through the relevant pipeline. Operation of these valves can be carried out remotely via a control system (not shown).

When a pre-compressor is required, the gas from the inlet separator 22 is carried through the pipeline 24i into the pre-compressor separator 24. The separator 24 removes further liquid from the gas so that it is sufficiently dry for the pre-compressor 30. Liquid is removed from the separator 24 via a condensate pipeline 13 and the gas is carried further toward the pre-compressor 30 via pre-compressor inlet pipeline 30i.

The gas then passes continuously through the pre-compressor 30 toward the outlet arrangement driven by pressure from the well. The pre-compressor 30 is provided with an anti-surge valve 32 which bridges the pre-compressor inlet and outlets 30i, 30x. The valve protects the compressor against flow surges into the suction portion of the pre-compressor 30 to prevent damage. It is also used to build up the pressure head in the pre-compressor before it is activated. This is done by closing the anti-surge valve 32. The speed of the pre-compressor turbine is also increased to increase the flow into the compressor and build up the pressure head further.

Further, a communication line 34 is provided between the inlet separator 22 and the pre-compressor 30, which is used in the preparation and control of the pre-compressor when the facility is prepared from the initial state into the pre-compressor connection state or mode. Typically, this may carry a signal relating input separator pressure to provide control of speed of the pre-compressor.

Fluid from the inlet arrangement 20 is passed through various intermediary processing arrangements 50 including separators, scrubbers, and heaters/coolers to remove other parts of the gas, for example glycol and/or carbon dioxide.

Thereafter, the gas passes into an outlet arrangement 70 through inlet pipeline 62. The outlet arrangement 70 includes in this example four parallel-connected expander/re-compressors 80 and an associated expander inlet separator 72 for processing the gas before entering the expander/re-compressors 80. The expander/re-compressors 80 re-compress the previously expanded gas (after circulation through an expander outlet separator) and then the re-compressed gas is sent to an export compressor 90, which provides the final compression of the gas for export as sales gas through main transport pipeline 14.

In more detail, the gas is received into the expander inlet separator 72 in which further liquid condensate is removed. The gas is carried from the expander inlet separator 72 via pipeline 72i and into the expander/re-compressors 80 which expand the gas to reduce its temperature and to knock out any remaining condensate. The condensate which is removed from the expander/re-compressors 80 and from the expander inlet separator 72 is fed into an expander outlet separator 74 via condensate inlet pipeline 74i. The expander outlet separator 74 performs a further gas/liquid separation. The condensate is removed via condensate pipeline 13 whilst the gas is led out of the expander outlet separator 74 along pipeline 76i. It is then carried further along pipeline 76r through heat exchanger 76 back into the expander/re-compressors 80 where the gas is compressed again. The gas exits the expander/re-compressors 80 along and into the export compressor 90.

Various communication lines 78a-c are provided in the outlet arrangement for controlling and feeding back information to the different equipment components about conditions elsewhere. A first line 78a extends between the expander inlet separator 72 and the expanders 80 and is typically used to carry a signal relating to the pressure of the expander inlet separator 72 for controlling the speed of the expanders. A second communication line 78b extends between the expander outlet separator 74 and a control valve 76v. The control valve is provided on a bridging pipe section across the inlet and outlet of the heat exchanger 76 and can be opened to let a first portion of the fluid in pipeline 76i bypass the heat exchanger (non-heated) and mix with a second portion of the gas in pipeline 76i which has been passed through the heat exchanger 76. This provides a certain temperature of the gas entering the expanders 80 for re-compression. The second communication line 78b typically carries a signal relating to the temperature of gas in the expander outlet separator 74 to provide the necessary control for the valve 76v. A third communication line 78c, connects between the expander outlet separator 74 and the export compressor 90. This line is used typically to carry a signal linking the pressure of the expander outlet separator 74 to the speed of the export compressor.

The different components of the inlet and outlet arrangements 20, 70 are controlled remotely by a control program. The various flow valves are controllable. Each of the separators operate at specific pressure and temperatures, and are balanced against each other to be able to perform the required liquid gas separation and to help ensure gas transported from the processing facility is at the required pressure, temperature and flow rate.

The following components and parameters are controllable by direct command from the control program, i.e. these components can be set by a user or user-operated program:

TABLE 1

| Component/apparatus | Parameter |
|---|---|
| Inlet separator 22 | pressure |
| Expander inlet separator 72 | pressure |
| Expander outlet separator 74 | pressure & |
| | temperature |
| Anti-surge valve 32 | open/closed |
| Pre-compressor 30 | on/off |

The following components and parameters are controlled indirectly (not by direct command). They are controlled by signals transmitted on the communication lines connecting them to the directly controllable components (listed in Table 1):

TABLE 2

| Component/apparatus | Parameter |
|---|---|
| Expander/Re-compressors 80 | speed |
| Pre-compressor 30 | speed |
| Export compressor 90 | speed |

A first set of parameters are provided for producing sales specification gas when in the facility is operating in the initial state and another set for doing so when the condition of the equipment is changed for connection of the pre-compressor. Thus, by moving or adjusting the various components between a set of first and a set of second parameter values the operating configuration or condition of the facility is changed from the initial or default state into the pre-compressor connection state.

The object of the transition between different states is to ensure that the sales gas specification is maintained, whilst the equipment is put into a state that allows the pre-compressor to be activated without disruption or without generating any effect apart from increasing the rate of export of sales gas.

The control operator or program may adjust the component parameters and may define the instructions, for example a rate of change of export compressor speed due to change in outlet expander separator pressure, to be communicated by signals between the different components on the communication lines 32, 78a-c.

In complex fluid processing facilities where there are multiple components and variables such as that shown in FIG. 1, a conservative approach has traditionally been taken with regard to making adjustments to the system. When changes are made, these have been done by making small incremental changes, typically one parameter at a time to see how the system responds. It has been thought that such an approach could make it easy to monitor effects of changing a particular parameter value or to reverse any adverse effects of changing a parameter. To support this approach, significant efforts have been made to provide safety routines in the control programs have built in routines to ensure accurate adjustment of parameters, prevent overshoots and prevent the system from operating out of specification.

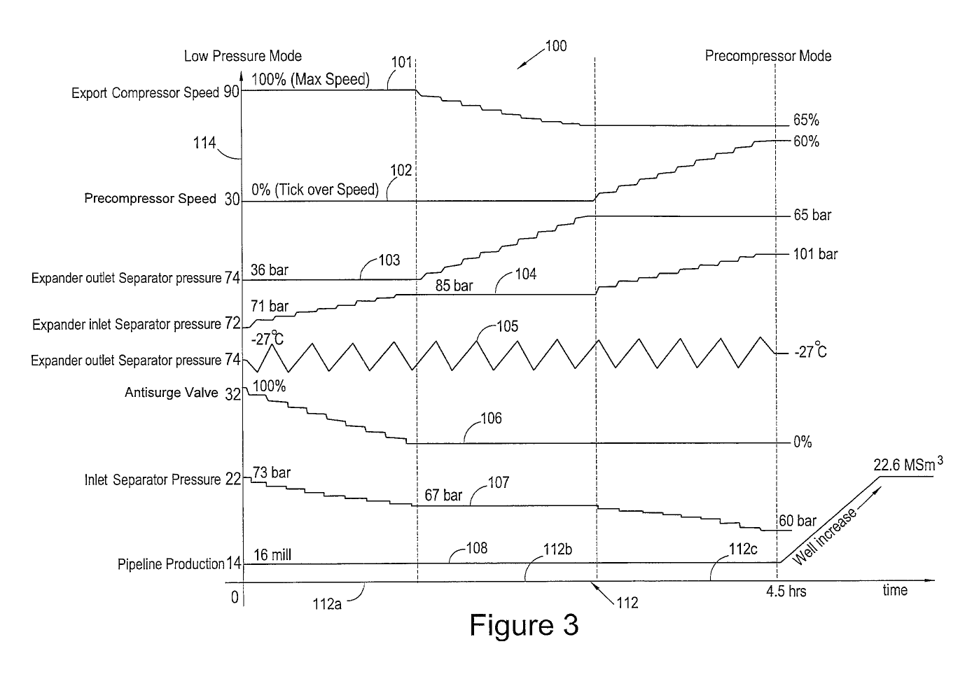

A typical sequence following this approach is described with further reference to FIG. 3 by which the operating state of the processing facility is prepared into its pre-compressor connection state by changing the values of parameters of the equipment components referred to in the tables above. The plot 100 shows the change in different parameters against time. The x-axis 112 represents time, and the y-axis 114 is a multi-axis of different parameter values. Time t=0 marks the start of the transition phase of preparing the equipment into the connection state. At this time, the well has been switched on and the facility has been operating in steady state fashion, with the parameters kept at near constant values, in this case exporting gas at a rate of 16 MSm³. This represents a maximum rate that can be achieved without the pre-compressor 22 connected whilst exporting specification sales gas. The export flow rate is indicated by the curve 108. Notably the export compressor speed indicated by curve 101 is at its maximum of 100%.

The control sequence is then started and proceeds in a stepwise manner. Over a first time period 112a, the anti-surge valve is closed in steps, as indicated by curve 106. At each step the anti-surge valve is closed, the pressure differential head in the pre-compressor increases causing an increase in components downstream and an increase the expander inlet separator pressure 104. In addition, the pressure of the inlet separator 22 is reduced a certain extent as shown in curve 107. At each step, the change in inlet separator pressure 104 in turn causes a change in the expander outlet separator temperature 105 as the differential pressure between the expander outlet separator and the expander outlet separator changes accordingly. However, the temperature signal provided through control line 78b causes the heat of the fluid leaving the expander outlet separator 74 to be adjusted back to what it was, whilst the change in the pressure in the expander inlet separator 72 produces a signal to the expanders via line 78c which increases the expansion of the expanders to bring the temperature 105 back down.

At each step of closure of anti-surge valve and increase in expander inlet separator pressure, there is a pause or braking of the process, to allow time for the temperature to return back, before then performing the next stepwise increment. During this phase 112a, the export flow rate increases marginally (not visible in curve 108).

After the first phase is complete, and the anti-surge valve 32 is closed, the pressure of expander outlet separator 74 is increased which causes a reduction in the export compressor speed. Again this is done in stepwise fashion. A pressure differential is created again between the between the expander outlet separator and the expander outlet separator giving rise to a similar temperature effect of the curve 105 during this phase. A marginal reduction in export flow rate occurs (although not visible in curve 108).

Into the final phase 112c, the pressure in the inlet separator 22 is reduced step-wise according to curve 107 and causing the pre-compressor speed to be increased by virtue of its data connection via line 34. The average export rate over the three phases is around 16 MSm³ but fluctuations take place along the way due to imbalances created by adjusting parameters “one-by-one” at different times, and making adjustments stepwise.

Once this third phase 112c is completed, the operating state is suitable for connection of the pre-compressor. The pre-compressor is connected and activated. It then acts on the fluid in the pipeline 30i to increase the pressure substantially. The export rate is then increased from 16 MSm³ to 22 MSm³, whilst the parameters remain near constant thereafter.

The change of operating state or configuration conducted in this manner is typically completed after about 4 to 5 hours. This is a costly limitation, because each time there is a requirement to switch off or on the fluid flow from the well and connect and/or disconnect the pre-compressor 4-5 hours represents a significant amount of time before the export of the sales gas can take place again at maximum rate. In addition, there are instabilities and imbalances manifested in that the export rates vary somewhat as individual parameters are adjusted.

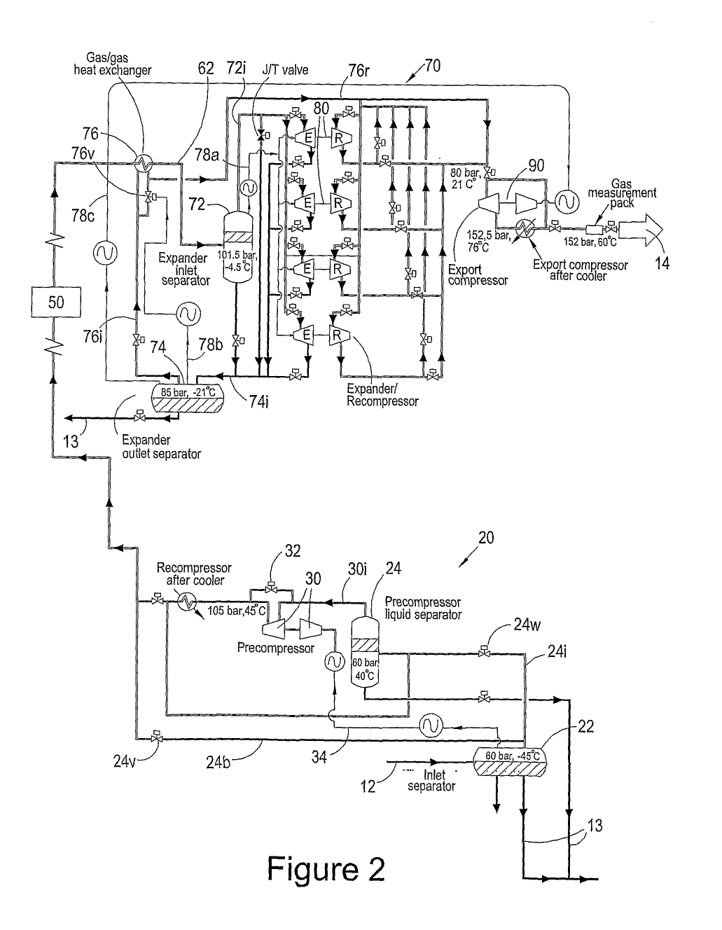

To take account of this, the control program for controlling the sequence in FIG. 2 is complex, to restrict and put a “brake” on the changes that are made to ensure that adjustments are carried out stepwise in small pre-specified increments.

According to an aspect of the invention there is provided a method of processing fluid from a well, the method comprising the steps of:
a. providing a fluid processing system operable to process fluids from a well in dependence on a plurality of controllable system parameters;
b. adjusting at least two of the system parameters between respective first and second parameter values, the first values defining a first operational configuration and the second values defining a second, different operational configuration suitable for activation of a compressor, and performing the adjustment such that the system is balanced whilst adjusting the at least two parameters; and
c. activating or de-activating a compressor in the second operational configuration for transport of fluid at a high or low fluid flow rate.

Typically, the flow rate of fluid processed by the system is substantially constant during step b. Thus, the flow rate in the second operational configuration is typically the same as the flow rate in the first condition until the compressor is activated. The composition of fluid processed by the system may also typically be constant, e.g. substantially the same, during step b. Thus, sales quality fluids may be exported or transported away from the system during a change in operational configuration.

Step b may include adjusting one of the at least two system parameters to at least partially counteract adjustment of at least one other of the system parameters for balancing the system.

The system may be balanced in terms of energy, i.e. no net change in energy or flow due to adjustment of parameters. Thus, the first values may together define a balanced system, and the second values may together define a balanced system. Furthermore, during performance of step b the parameters have respective intermediate values, e.g. intermediate in time and/or in value, between the first and second values, and the intermediate values of the parameters also typically define a balanced system. Thus, adjustment of each parameter follows a path extending between the first and second value of the parameter, and for each point in time along the path, respective parameters define a balanced system.

The method may include starting adjustment of each of the at least two parameters in step b at about the same time. The method may include ending adjustment of each of the at least two parameters in step b at about the same time, e.g., when or as soon as the second values have been reached or, when performing the method in reverse, when or as soon as the first values have been reached.

Step b may comprise adjusting each parameter substantially smoothly between the first and second values. For example, the parameters may be adjusted or controlled follow a smooth path, curve or function in time between the first and second values. Step b may comprise adjusting each parameter substantially linearly between the first and second values. For example, the parameters may be adjusted or controlled to follow a linear or straight-line path, curve or time function between the first and second values. Step b may comprise increasing at least one of the parameters from the first value to the second value. Step b may comprise decreasing at least one of the parameters from the first value to the second value. Step b may include adjusting the parameters by keeping the first and second values of one of the parameters the same and by changing at least one other of parameters from the first to the second value. Step b may include adjusting the least two parameters simultaneously between the first and second values.

Each of the at least two system parameters may be selected from the group consisting of:
i. valve open/closed status;
ii. compressor status;
iii. fluid temperature; and
iv. fluid pressure.

The compressor is a pre-compressor. The method may include connecting the pre-compressor near a fluid inlet of the system.

The system may include fluid processing apparatus selected from the group consisting of:
i. an inlet separator for separating raw fluid from the well into liquid and gas constituents;
ii. a pre-compressor arrangement comprising a pre-compressor and an anti-surge valve connected between an outlet and an inlet of the pre-compressor;
iii. an outlet arrangement comprising one or more of the following: at least one expander; an expander inlet separator connected to an inlet to the expander; an expander outlet separator connected to an outlet of the expander; and at least one outlet/export compressor.

The at least two parameters may comprise a parameter associated with the fluid processing apparatus selected from the group consisting of:
i. anti-surge valve open/closed status;
ii. inlet separator pressure;
iii. expander outlet separator temperature;
iv. expander outlet separator pressure;
v. expander inlet separator pressure;
vi. outlet/export compressor speed; and
vii. pre-compressor speed.

According to another aspect of the invention, there is provided a method of maintaining pressure in the export gas from an oil well, where in the process there is inserted a pre-compressor which separates gas and liquid from the stream from the well, to increase the pressure in the gas from the well before it is sent onward in the process; where a plurality of expander/re-compressors are placed downstream of an expander inlet separator; and an export compressor is placed at the end of the process in relation to the export line, wherein the speed of the pre-compressor is steered such that the desired pressure in the gas in an inlet separator upstream of said pre-compressor.

Embodiments of the invention will now be described, by way of example only, with reference to the accompanying drawings, in which:

FIGS. 1A and 1B provide a schematic overview of a typical prior art fluid processing facility;

FIG. 2 is a schematic overview of the inlet and outlet arrangements of the prior art fluid processing facility of FIGS. 1A and 1B;

FIG. 3 is a graph showing a typical prior art operating sequence for the fluid processing facility of FIGS. 1A and 1B; and

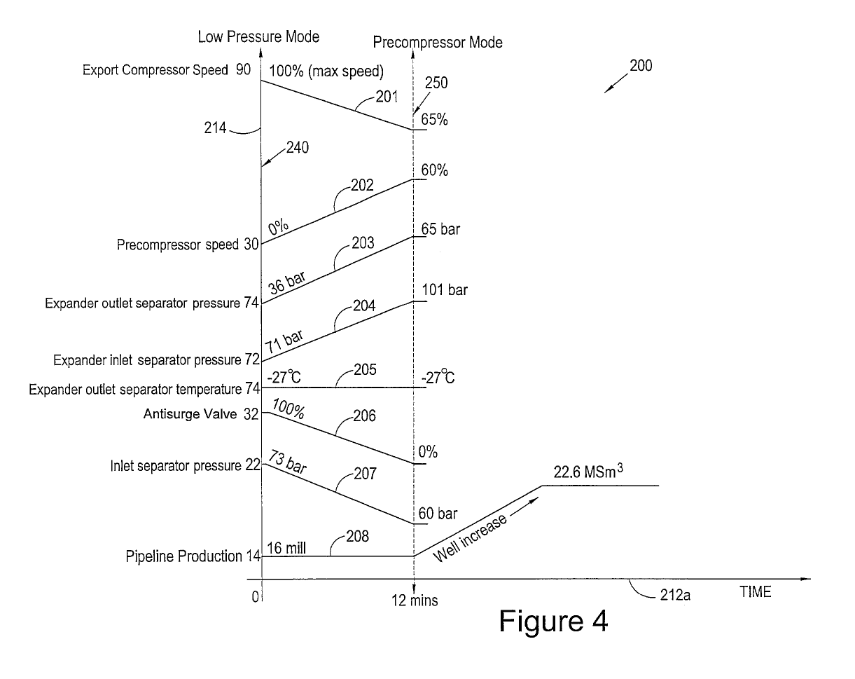

FIG. 4 is a graph showing a method of controlling a fluid processing system according to an embodiment of the invention.

With reference to FIG. 4, the operation of a fluid processing system is shown in a graph 200, the x-axis 212a defining time, and the y-axis 214 being a multi-axis of different parameter values. This is described with reference to the system as shown in FIGS. 1A, 1B and 2. Time t=0 on this graph 200 marks a start of the transition phase for preparing the system into a pre-compressor connection state. At this time, the well is switched on and the facility has been operating in steady state fashion. The parameters are those referred to in tables 1 and 2 above. Prior to time t=0, these are kept near constant, in this case exporting gas at a rate of 16 MSm³, representing a maximum rate that can be achieved without the pre-compressor 30 connected whilst exporting specification sales gas. The export flow rate is indicated by the curve 208.

As can be seen in FIG. 4, all of the parameters are adjusted between their initial, start values and their end values in a single short-duration phase of around 12 minutes. Moreover, each parameter follows a straight line/linear curve from the initial value to the end value.

As soon as the sequence is initiated, the adjustments needed to move the parameters between the initial and end values take place. The anti-surge valve 32 is gradually closed from its initial 100% fully open value following curve 206. Closure of the anti-surge valve increases the pressure differential or “head” in the pre-compressor 30. Accordingly, pressure is increased downstream of the pre-compressor 30, in particular the pressure of the expander inlet separator 72. The pressure of the inlet separator 22 upstream of the pre-compressor 32 is decreased as shown in curve 207.

As mentioned above in this system, gas flows from the expander inlet separator 72, into the expanders/re-compressors 80 and out from the expander portion of the expanders/re-compressors 80 via the expander outlet separator 74 and heat exchanger 76 into the re-compression portions of the expanders/re-compressors 80 and then into the export compressor 90.

The increase in pressure of the expander inlet separator 72 causes an increased expansion of the fluid, thus a decrease in fluid temperature which is balanced out by an increase in pressure of the expander outlet separator 74 as shown in curve 203. The pressure of the expander outlet separator 74 is increased by the same amount (and at the same rate) as the expander inlet separator 72. This ensures that the differential pressure between them is constant and that the temperature of the expander outlet separator 74 remains constant as shown in curve 205.

With the increase in pressure of the expander outlet separator 74, export compressor speed is reduced according to curve 201 from 100% to 65% of full speed by way of the communication link between the expander outlet separator 74 and the export compressor 90 by the communication line 78c. Thus, the speed of the export compressor 90 is changed to compensate for the increase in pressure of the expander outlet separator 74. Therefore, despite the speed reduction of the export compressor 90, the flow rate of the sales gas transported from the system into the pipeline 14 does not change.

At the inlet arrangement 20, an increase in speed of the pre-compressor 30 as seen in curve 202 is compensated by reduction in pressure of the inlet separator 22 by virtue of the communication link provided by line 34. The reduction in pressure at the inlet separator 22 counter acts the pressure increases in the system upstream of the pre-compressor.

As a result of the adjustment of parameters as described above, the system remains balanced during the transition at all points in time along the time curves 201-207. Typically, if one parameter is increased the imbalance of instability that would otherwise be caused is prevented by simultaneous changes of other parameters. There is no net change in energy and the export rate and composition of fluid remains constant. Nevertheless, the system is changed from a first operational configuration 240 defined by the initial values, and a second operational configuration 250 defined by the end values.

When the second operational configuration has been reached, the parameters are such that the pre-compressor can simply be activated without disruption. The pressure lift and speed is in the correct condition for connection. The pre-compressor is then activated. This generates an increase in flow rate of fluid exported from the facility from 16 MSm³ to 22 MSm³.

When a well is to be shut off temporarily and the production rate needs to be reduced back down, the process and transition is performed in exactly the reverse manner. The pre-compressor is disconnected, and the parameters are adjusted from the second configuration 250 to the first configuration 240. Then, the values of each parameter in the second configuration 250 represent start values for the change in operating state or configuration, and the values of the first configuration 240 represent end values.

The present invention provides significant advantages. The process for preparing the system into a state for connection of the pre-compressor is significantly simplified, since moving the parameters between their start and end values simultaneously along linear curves keeps the system balanced. It is also significantly quicker than existing methods such that the shut down time for production is reduced, and accordingly production at full rate can be brought online again much quicker.

Various modifications and/or changes may be made without departing from the scope of the invention herein described.

1-16. (canceled)

17. A method of processing fluid from a well, the method comprising the steps of:
a. providing a fluid processing system operable to process fluids from a well in dependence on a plurality of controllable system parameters;
b. adjusting at least two of the system parameters substantially smoothly between respective first and second parameter values, the first values defining a first operational configuration and the second values defining a second, different operational configuration suitable for activation of a compressor, and performing the adjustment such that the system is balanced whilst adjusting the at least two parameters; and
c. activating or de-activating a compressor in the second operational configuration for transport of fluid at a high or low fluid flow rate.

18. A method as claimed in claim 17, wherein the flow rate of fluid processed by the system is substantially constant during step b.

19. A method as claimed in claim 17, wherein step b includes adjusting one of the at least two system parameters to at least partially counteract adjustment of at least one other of the system parameters for balancing the system.

20. A method as claimed in claim 17, wherein the method includes starting adjustment of each of the at least two parameters in step b at the same time.

21. A method as claimed in claim 17, wherein the method includes ending adjustment of each of the at least two parameters in step b at the same time.

22. A method as claimed in claim 17, wherein step b comprises adjusting each parameter substantially linearly between the first and second values.

23. A method as claimed in claim 17, wherein step b comprises increasing at least one of the parameters from the first value to the second value.

24. A method as claimed in claim 17, wherein step b comprises decreasing at least one of the parameters from the first value to the second value.

25. A method as claimed in claim 17, wherein step b includes adjusting the parameters by keeping the first and second values of one of the parameters substantially constant and by changing at least one other of parameters from the first to the second value.

26. A method as claimed in claim 17, wherein step b includes adjusting the least two parameters simultaneously between the first and second values.

27. A method as claimed in claim 17, wherein each of the at least two system parameters are selected from the group consisting of:
i. valve open/closed status;
ii. compressor status;
iii. fluid temperature; and
iv. fluid pressure.

28. A method as claimed in claim 17, wherein the compressor is a pre-compressor.

29. A method as claimed in claim 28, wherein the method includes connecting the pre-compressor near a fluid inlet of the system.

30. A method as claimed in claim 17, wherein the system includes fluid processing apparatus selected from the group consisting of
i. an inlet separator for separating raw fluid from the well into liquid and gas constituents;
ii. a pre-compressor arrangement comprising a pre-compressor and an anti-surge valve connected between an outlet and an inlet of the pre-compressor;
iii. an outlet arrangement comprising one or more of the following: at least one expander; an expander inlet separator connected to an inlet to the expander; an expander outlet separator connected to an outlet of the expander; and at least one outlet/export compressor.

31. A method as claimed in claim 30, wherein the at least two parameters comprises a parameter associated with the fluid processing apparatus selected from the group consisting of:
i. anti-surge valve open/closed status;
ii. inlet separator pressure;
iii. expander outlet separator temperature;
iv. expander outlet separator pressure;
v. expander inlet separator pressure;
vi. outlet/export compressor speed; and
vii. pre-compressor speed.
